(19) United States
(12) Patent Application Publication
(10) Pub. No.: US 2014/0046796 A1
(43) Pub. Date: Feb. 13, 2014

(54) Digital Commerce Systems and Methods Facilitating Charitable Giving

(71) Applicant: REDIGI, INC., (US)

(72) Inventors: Lawrence S. Rogel, Brookline, MA (US); Colin Worth, Boston, MA (US); Jonathan Lin, Boston, MA (US); Xiao Zhou, Roxbury Crossing, MA (US); Jose Soto, Boston, MA (US); Jason J. Ossenmacher, Mission Viejo, CA (US); John M. Ossenmacher, Balboa Island, CA (US)

(73) Assignee: REDIGI, INC., Boston, MA (US)

(21) Appl. No.: 13/838,188

(22) Filed: Mar. 15, 2013

Related U.S. Application Data
(60) Provisional application No. 61/624,003, filed on Apr. 13, 2012.

(51) Int. Cl. G06Q 30/06

(52) U.S. Cl. CPC G06Q 30/0613
USPC 705/26.41

(57) ABSTRACT

The invention provides, in some aspects, a digital commerce system that includes first and second digital data devices that are coupled with a server digital data processor via a network supporting at least intermittent communications therebetween. The server digital data processor is responsive to requests by owners/operators of those digital data devices for (i) selling or otherwise transferring ownership of or other rights in an object from an owner/operator of the first digital data device to an owner/operator of the second digital data device, and (ii) transferring any of credits and/or monetary funds (collectively, “funds”) from an owner/operator of the second digital data device to a charity designated by the owner/operator of the first digital data device.

This application claims the benefit of filing of U.S. Patent Application Ser. No. 61/624,003, filed Apr. 13, 2012, entitled “Digital Commerce Systems and Methods Facilitating Charitable Giving,” the teachings of which are incorporated herein by reference.

### BACKGROUND OF THE INVENTION

The invention pertains to digital commerce and, more particularly, to systems and methods for the electronic purchase of items that encourage donation by sellers. The invention has application, inter alia, in the sale of music and other digital media on the web.

Philanthropy, like the economy, has lagged over the past decade. Although the efforts of Ted Turner and others have boosted giving among the more affluent, job losses and wage uncertainty have depressed giving at the lower echelons. The opportunities, however, still abound as attested to by donation canisters at checkout counters across the country.

While charitable giving is on the decline, digital commerce is not—with growth in the range of 10%-20% per annum, even during the economic downturn. Of course, some sectors have not fared as well as others. Digital music album sales, for example, were flat during the heart of the recession—though, technology introduced by the assignee hereof (as exemplified, for example, by the teachings of U.S. patent application Ser. No. 12/983,257, Publ. No. US-2011-0162086-A1) to create secondary markets in digital music and other media. is hoped will remedy this. Regardless, the challenge for charitable organizations is to capitalize on the growth of digital commerce and, thereby, to get a head start on the recouping losses of the last decade.

In view of the foregoing, an object of the invention is to provide improved methods and systems for digital commerce.

A related object is to provide such improved methods and systems as facilitate charitable giving.

A further related object is to provide such improved methods and systems as can be utilized in connection with the sale of digital music and other media.

Yet a still further related object is to provide such methods and systems as can be utilized in connection with secondary e-commence markets, e.g., markets in the sale of “previously owned” digital media.

Still yet another object is to provide such methods and systems as can be utilized in connection with other e-commerce transactions.

### SUMMARY OF INVENTION

The foregoing are among the objects attained by the invention which provides in some aspects, a digital commerce system that includes first and second digital data devices that are coupled with a server digital data processor via a network supporting at least intermittent communications therebetween. The server digital data processor is responsive to requests by owners and/or operators (each, hereinafter, respectively an “owner/operator”) of those digital data devices for (i) selling or otherwise transferring ownership of or other rights in an object from an owner/operator of the first digital data device to an owner/operator of the second digital data device, and (ii) transferring any of credits and/or monetary funds (collectively, “funds”) from an owner/operator of the second digital data device to a charity designated by the owner/operator of the first digital data device.

Further related aspects of the invention provide a digital commerce system, e.g., as described above, wherein the server digital data processor responds to a request by the owner/operator of the first digital data device to transfer ownership of (or other rights in) the object by applying a credit to an account of that owner/operator.

Still further related aspects of the invention provide a digital commerce system, e.g., as described above, wherein the server digital data processor transfers monetary funds from a bank account associated with the owner/operator of the second digital data device in the amount of a purchase price of the object, offset by a credit owed to that owner/operator.

Yet still further related aspects of the invention provide a digital commerce system, e.g., as described above, wherein the server digital data processor normally responds to the request by the owner/operator of the second digital data device by transferring funds in the amount of a purchase price of the object, offset by a credit owed to that owner/operator, but wherein the server is responsive to a request by that owner/operator to forego such offsetting.

Still yet further related aspects of the invention provide a digital commerce system, e.g., as described above, wherein the server digital data processor issues a tax receipt to the owner/operator of the first digital data device.

Yet still yet further aspects of the invention provide a digital commerce system, e.g., as described above wherein the object is any of a digital song, a digital video, a digital movie, an electronic book, a digital story, a digital article, a digital document, a digital still image, a digital game, or a portion thereof.

In other aspects, the invention provides a digital commerce system that includes first and second digital data devices that are coupled with a server digital data processor via a network supporting at least intermittent communications therebetween. The server digital data processor is responsive to a request by an owner/operator (“first owner/operator”) of the first digital data device for transferring ownership of or other rights in an object from an owner/operator of the first digital data device to a designated charity. The server digital data processor is further responsive to a request by an owner/operator (“second owner/operator”) of the second digital data device by transferring any of credits and/or monetary funds (collectively, “funds”) from that second owner/operator to the charity and by transferring ownership of or other rights in the object from the charity to that owner/operator.

Related aspects of the invention provide a digital commerce system, e.g., as described above, wherein the server digital data processor responds to the request by the owner/operator of the first digital data device by applying a credit to an account of that owner/operator.

Still further related aspects of the invention provide a digital commerce system, e.g., as described above wherein the server digital data processor responds to the request by the owner/operator of the second digital data device by transferring funds in the amount of a purchase price of the object, offset by a credit owed to that second owner/operator.

Yet still further related aspects of the invention provide a digital commerce system, e.g., as described above wherein the server digital data processor normally responds to the request by the owner/operator of the second digital data device by transferring funds in the amount of a purchase price of the object, offset by a credit owed to that owner/operator, but wherein the server is responsive to a request by that owner/operator to forego such offsetting.

Still yet further related aspects of the invention provide a digital commerce system, e.g., as described above wherein the server digital data processor issues a tax receipt to the owner/operator of the first digital data device.

Other aspects of the invention provides methods of digital data commerce paralleling operations of the systems described above.

These and other aspects of the invention are evident in the drawings and the discussion that follows.

### BRIEF DESCRIPTION OF THE DRAWINGS

A further appreciation of the invention may be attained by reference to the drawings, in which

FIG. 1 depicts a system according to the invention and an environment in which it operates;

FIG. 2 depicts operation of the system of FIG. 1 in connection with the sale or other transfer of digital media objects; and

FIG. 3 depicts operation of the system of FIG. 1 to facilitate charitable giving.

### DETAILED DESCRIPTION OF THE ILLUSTRATED EMBODIMENT

Architecture

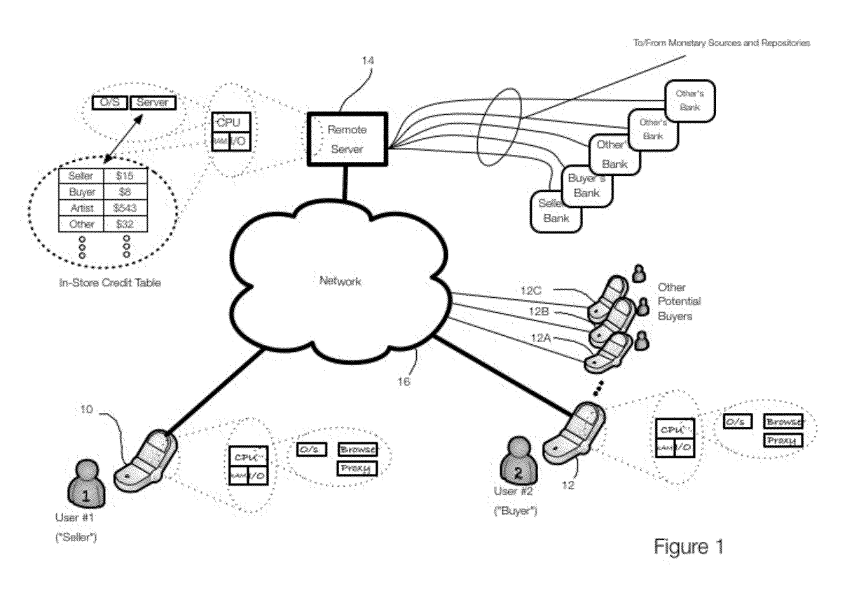

FIG. 1 depicts a system for digital commerce according to one practice of the invention. The illustrated system includes digital data devices 10, 12 that are coupled to server 14 via network 16. The illustrated system is depicted here and described below in respect to facilitating donation of proceeds from an e-commerce sale (or other transfer) of “previously owned” digital music and other media files, although it will be appreciated that the system (and methods of operation thereof) have application to facilitating such donations in connection with e-commerce sales of “new” digital music and other media files (i.e., those that have not been previously owned) and in a wide variety of other contexts, as well. It will also be appreciated that other embodiments may employ architectures other than that shown by way of example here.

Digital data devices, 10, 12 of the illustrated embodiment are conventional computing devices of the type commercially available in the marketplace for use in mobile computing, e.g., smart phones, personal digital assistants (PDAs), eReaders, video consoles, movie players and other dedicated digital data devices, and so forth, as adapted in accord with the teachings hereof. In other embodiments, the digital data devices can be other portable, semi-portable or fixed computing devices, such as laptop computers, desktop computers, workstations, and so forth, of the type commercially available in the marketplace, again, as adapted in accord with the teachings hereof. As well, they can be embedded computing devices as adapted in accord with the teachings hereof. Indeed, in some embodiments, one or more of the digital data devices 10, 12 can be embodied in a kiosk, e.g., a digital data processor that includes a screen (and/or other output) and keyboard (and/or other input) all contained in a housing or otherwise for use by members of the public, conference attendees, and/or others at public, semi-public or other sites.

Regardless, the digital data devices can transmit and/or receive information via wired or wireless communications, all in the conventional manner known in the art as adapted in accord with the teachings hereof.

For simplicity and without loss of generality, the owners and/or operators (each, hereinafter, respectively an “owner/operator”) of digital data devices 10, 12 are sometimes referred to as Owner/Operator 1 and Owner/Operator 2, respectively—though, in many of the examples given here, they are alternatively referred to as the “seller” and the “buyer,” respectively. The drawing shows a plurality of other potential “buyers” (each associated with his or her own respective device 12A-12C). A plurality of others “sellers” (like that associated with device 10) could likewise be shown, but they are not, here, for sake of simplicity.

Illustrated devices, 10, 12 each include central processing unit (CPU), memory (RAM), and input/output (I/O) subsections of the type commonly incorporated in respective devices of the type discussed above. Those subsections may include and execute (particularly, for example, in the case of the CPU) an operating system, a web browser, and/or other software of the type commonly provided and configured for execution on such devices—again, as adapted in accord with the teachings hereof. Those subsections may, further, include and execute additional software effecting the functionality discussed below attributed to the respective devices 10, 12. The digital data devices, 10, 12 also include displays (not shown) of the type commonly used in respective devices of the type discussed above, e.g., for the display of information in web browsers, applications, apps or otherwise. And, those devices 10, 12 can include keyboards (virtual, physical or otherwise) of the type commonly employed on such devices, e.g., for the input of information into web browsers, applications, apps or otherwise.

Server 14 oversees digital commerce transactions between devices 10, 12 and, more particularly the owners/operators thereof. The server 14 comprises a conventional digital data processor of the type commercially available in the marketplace for use as web, commerce or other servers, such as, personal computers, workstations, mini computers, mainframes, and so forth—all as adapted in accord with the teachings hereof. Server digital data processor 14, too, may include central processing unit (CPU), memory (RAM), and input/output (I/O) subsections of the type commonly incorporated in respective devices of the type described above. Those subsections may include and execute (particularly, for example, in the case of the CPU) an operating system and e-commerce web server software (or other application or app) of the type commonly provided and configured for execution on such device, again, as adapted in accord with the teachings hereof. And, again, those subsections may, further, include and execute additional software effecting the functionality discussed below attributed to the respective server 14.

Network 16 comprises a combination of one or more wireless, wired or other networks of the type commercially available in the marketplace for supporting at least intermittent communications between the illustrated devices (e.g., digital data devices 10, 12 and server 14) including, for example, LAN, WAN, MAN, cellular, Wi-Fi, local area, satellite, and/or other networks—again, all as adapted in accord with the teachings hereof. Although only a single network 16 is shown in the drawing, it will be appreciated that in other embodiments multiple networks may be employed.

Operation

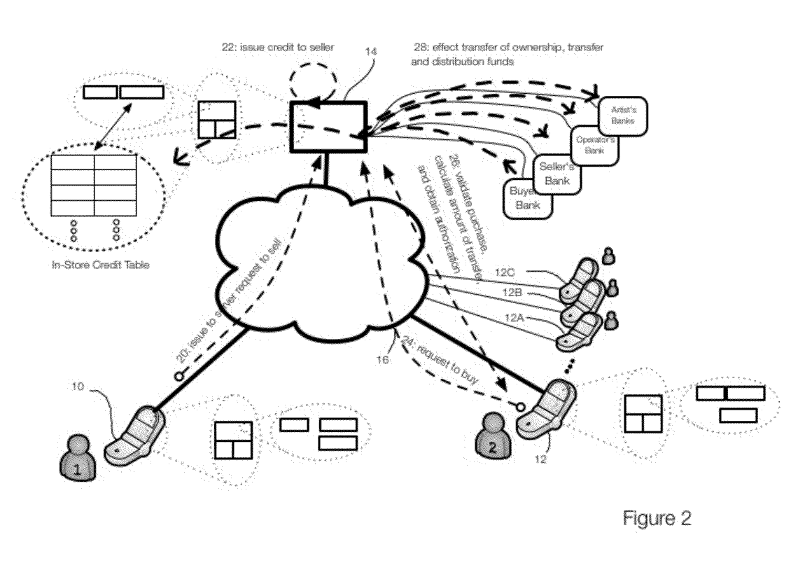

FIG. 2 illustrates a mechanism for facilitating an e-commerce transaction in a system according to the invention—and, particularly, by way of non-limiting example, for facilitating the e-commerce sale, mediated by server 14, of a previously owned digital song or other digital media object (“DMO”), e.g., a digital video, a digital movie, an electronic book, a digital story, a digital article, a digital document, a digital still image, a digital game, or a portion thereof, from Owner/Operator 1 to Owner/Operator 2 in an e-commerce transaction between devices 10, 12. Of course, it will be appreciated that they like system can be employed in connection with “new” DMOs (i.e., DMOs that have not been previously owned), as well or in addition.

To that end, devices 10, 12 and server 14 of the illustrated embodiment can be constructed and operated in the conventional manner of such devices known in the art—all as adapted for operation in accord with the teachings hereof. Alternatively, in preferred embodiments, devices 10, 12 and 14 are constructed and operate in the manner of personal computer (22, 22′) and remote server (20), respectively, described in U.S. patent application Ser. No. 12/983,257, filed Dec. 31, 2010 (Publ. No. US-2011-0162086-A1) and in U.S. patent application Ser. Nos. 13/406,237 and corresponding PCT Patent Application Serial No. PCT/US2012/026,776 (now, Publication No. WO 2012/116365), both filed Feb. 27, 2012, all entitled METHODS AND APPARATUS FOR SHARING, TRANSFERRING AND REMOVING PREVIOUSLY OWNED DIGITAL MEDIA, the teachings of all of which are incorporated by reference herein.

For example, devices 10, 12 and server 14 of the illustrated embodiment can architected and operated as described in the aforesaid applications in regard to the purchase, sale, return, transfer, access, lending, streaming, validation, etc., of digital music files and other digital media objects—all as adapted in accord with the teachings hereof. By way of non-limiting example, the CPU, RAM and I/O subsections of respective devices 10, 12 and/or server 14 of the illustrated embodiment can execute management software or like functionality of the aforesaid incorporated-by-reference applications in support of such purchase, sale, return, transfer, access, lending, streaming, validation, etc., of digital media objects—again, as adapted in accord with the teachings hereof.

In view of the foregoing, server 14 of the illustrated embodiment and, particularly, the aforementioned e-commerce software, can include a table reflecting the status of user or member accounts, including, as germane here, the owner/operator's respective in-store credits. That table can be stored on disk, and in RAM or otherwise, as is common in the art (as adapted in view of the teachings hereof). Likewise, server 14 and, particularly, the aforementioned e-commerce software, can be coupled for communications, e.g., via network 16 or otherwise, to bank accounts, credit card accounts or other monetary accounts or funds repository (collectively, hereinafter, “bank account”) associated with the owner/operator of the digital store, Owner/Operator 1 (the seller), Owner/Operator 2 (the buyer), prospective buyers 12A-12C, and other owners/operators of the digital commerce store, as well as those of various third parties, including, for example artists and others behind creative works embodied in digital media objects bought, sold or otherwise transacted-in in that store, among others, all by way of non-limiting example.

In other embodiments, digital devices 10, 12 and/or server 14 maybe architected and or operated in other ways (e.g., known in the art or otherwise), as adapted in accord with the teachings hereof.

Turning to FIG. 2, in step 20, digital data device 10 issues to server 14 a request to sell a digital media object. In the illustrated embodiment, this is communicated by a web page form(s), e.g., via HTTP or otherwise, by special-purpose application or app executing on device 10, by e-mail transmitted from device 10. The request can be communicated at the behest of the Owner/Operator 1 of device 10, e.g., in response to an ad hoc command issued by the owner/operator, though it can be communicated as part of a batch process, as part of a queued set of commands stored in that device or otherwise, and/or in response to a request initiated by the server 14 and/or device 12.

As used herein, the term “request to sell,” or the like, includes a pledge or commitment to sell which pledge or commitment is subsequently validated by its maker, typically, in the case of the illustrated embodiment as where the pledge or commitment is made by an owner/operator on a kiosk, a mobile device and/or using a mobile app and where the validation is subsequently made by the owner/operator on another of his/her digital data devices, e.g., a desktop computer (and, particularly, where that other digital data device is one on which the pledged or committed DMO is stored).

The digital media object offered for sale may be stored on the device 10, the server 14, or elsewhere—though, in the illustrated embodiment, it is a digital media object that has or will be uploaded to the server 14 and validated for sale, e.g., in the manner consistent with that illustrated and described, by way of non-limiting example, in connection with steps 101-108 of aforementioned incorporated by reference U.S. patent application Ser. No. 13/406,237 and corresponding PCT Patent Application Serial No. PCT/US2012/026,776 (now, Publication No. WO 2012/116365).

In step 22, the server 14 issues an in-store credit C1 to the owner/operator of device 10 and, particularly, to his/her account in a digital commerce “store” operated in connection with the server 14 and under the auspices of which the e-commerce transaction is effected. The credit, which may be considered an incentive and/or compensation for the offer to sell, is typically a default amount, e.g., $0.50 per digital media object—though its value may be set on any of a number of bases. In the illustrated embodiment, issuance of the credit is effected by e-commerce software executing on server 14, e.g., optionally in cooperation with that executing on device 10. In the illustrated embodiment, the credit is neither cash nor redeemable for cash; rather, it may be used by the owner/operator alone and/or in combination with other credits for the purchase of digital media objects in that same e-commerce store, in related retail venues, or otherwise. Depending on the embodiment, in the event the owner/operator of device 10 makes a pledge or commitment, one or more actions of step 22 may be deferred until he/she validates that pledge or commitment.

In step 24, digital data device 12 issues to server 14 a request to buy the digital media object. In the illustrated embodiment, this is communicated by a web page form(s), e.g., via HTTP or otherwise, by special-purpose application or app executing on device 12, by e-mail transmitted from device 12. The request may be in response to a listing published by server 14 (and, particularly, for example, by the aforementioned e-commerce software operating in conjunction with the aforementioned server software) of digital media objects currently being offered for sale) to device 12 and those of other potential buyers (12A-12C), it may be in response to an ad hoc command issued by the owner/operator of device 12 coincident with the request to sell by the owner/operator of device 10, it may be in connection with an auction (e.g., commenced by the aforementioned e-commerce software operating in conjunction with the aforementioned server software), or otherwise.

As used herein, the term “request to buy,” or the like, includes a pledge or commitment to buy, which pledge or commitment is subsequently validated by its maker, typically, in the case of the illustrated embodiment as where the pledge or commitment is made by an owner/operator on a kiosk, a mobile device and/or using a mobile app and where the validation is subsequently made by the owner/operator on another of his/her digital data devices, e.g., a desktop computer.

The request issued by device 12 can be for a default purchase price (e.g., as specified in terms of service of the aforementioned e-commerce store); a purchase price agreed upon between the seller and the buyer, e.g., via an exchange of messages (not shown here) or otherwise facilitated by devices 10, 12 and/or server 14, or otherwise; a purchase price reached through an auction process (e.g., commenced by the aforementioned e-commerce software); or otherwise.

In step 26, the server 14 can validate the request to buy issued by device 12 (e.g., in the manner consistent with that illustrated and described, by way of non-limiting example, in connection with steps 109 of aforementioned incorporated by reference U.S. patent application Ser. Nos. 13/406,237 and corresponding PCT Patent Application Serial No. PCT/US2012/026,776 (now, Publication No. WO 2012/116365)). This can include obtaining from the buyer (via communication with device 12) payment authorization of the type conventional in the marketplace for online purchases—e.g., authorization to transfer those funds from a bank account, credit card account or other funding source of the buyer's. In the drawing, that is denoted “Buyer's Bank Account” for sake of simplicity, by way of example, and without loss of generality.

While revalidation and authorization can be for the entire purchase price, in many instances this will be for an amount D1 that is equal to the purchase price minus any credit C2 owed by the e-commerce store to the buyer, e.g., in connection with his/her own prior offers for sale (or other transactions) on the site. The server 14 (and particularly, for example, the aforementioned e-commerce software executing thereon) determines that amount D1 in step 26, as well.

In step 28, the server 14 (and, particularly, the aforementioned e-commerce software executing thereon) utilizes the authorization obtained from the buyer in step 26 to effect a monetary transfer of the amount D1 from the buyer's bank account—assuming that the purchase price is greater than C2 and, therefore, that D1 is positive). The server 14 also transfers ownership of (or other rights in) the digital media object from the seller to the buyer, e.g., utilizing an atomic transaction of the type in and described, by way of non-limiting example, in connection with steps 110 of aforementioned incorporated by reference U.S. patent application Ser. Nos. 13/406,237 and corresponding PCT Patent Application Serial No. PCT/US2012/026,776 (now, Publication No. WO 2012/116365)).

Furthermore, the server effects distribution of funds in the amount of the purchase price (as offset, in some embodiments, by any credit C2 applied thereagainst) to bank accounts associated with (i) the seller (e.g., offset by any credit, C1, previously issued to the seller in connection with step 22) and (ii) the operator of the digital commerce store in the conventional manner known in the art, as adapted in accord with the teachings hereof. Thus, for example, in some embodiments the entirety of the funds are transferred to the bank account associated with the store operator, and the seller is given an in-store credit for his/her share. In these and other embodiments, some of the funds may also be transferred to bank accounts (or in-store credit lines) associated with creative artists and others behind the digital media object that was the subject of the transaction, again, by way of example.

Depending on the embodiment, in the event the owner/operator of device 12 makes a pledge or commitment, the actions of steps 26 and 28 may be deferred until he/she validates that pledge or commitment.

Facilitating Donations

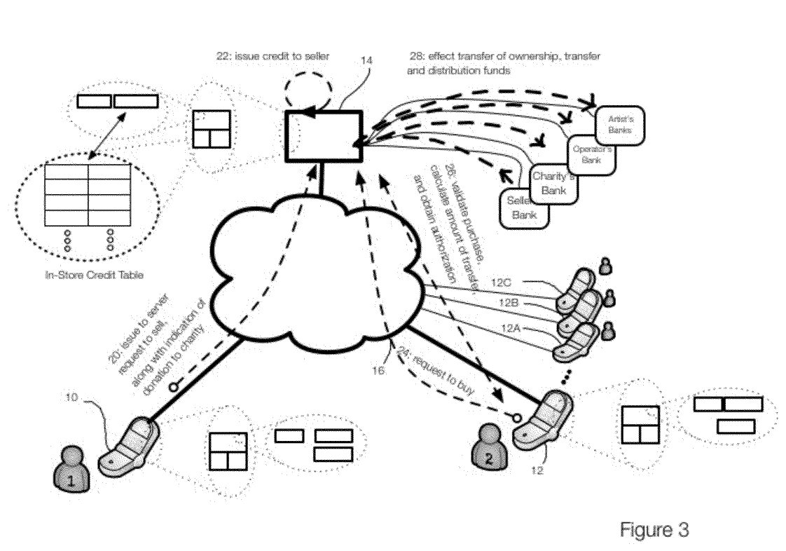

FIG. 3 illustrates a mechanism for facilitating donation in an e-commerce transaction in a system according to the invention—and, particularly, by way of non-limiting example, for facilitating donation of the proceeds of the e-commerce sale or other transfer, mediated by server 14, of a “new,” “previously owned” or other digital song or other digital media object (“DMO”), e.g., a digital video, a digital movie, an electronic book, a digital story, a digital article, a digital document, a digital still image, a digital game, or a portion thereof, from Owner/Operator 1 to Owner/Operator 2 in an e-commerce transaction between devices 10, 12.

Although the illustrated embodiment facilitates donation to charity of the proceeds of sales of digital media objects from Owner/Operator 1 to Owner/Operator 2 in e-commerce transactions mediated by server 14, in other embodiments, systems and methods according to the invention can facilitate such donations in connection with other e-commerce transactions, regardless of whether they are between devices 10, 12, their respective owners/operators, are in regard to digital media objects, or otherwise.

The mechanism of FIG. 3 operates in the manner of that described above in connection with FIG. 2, except as described below and elsewhere herein. Thus, for example, in step 20, digital data device 10 issues to server 14 a request to sell a digital media object. And, in step 22, the server 14 issues an in-store credit C1 to the owner/operator of device 10, e.g., as an incentive and/or compensation for the offer to sell. Moreover, by way of example, in step 24, digital data device 12 issues to server 14 a request to buy the digital media object, e.g., for a default purchase price or otherwise. In step 26, the server 14 validates the request from the owner/operator of device 12 and, in step 28, effects a transfer of ownership of (or other rights in) the digital media object in exchange for a transfer (for distribution) of funds from that owner/operator. As above, the actions of one or more of these steps may be deferred until validation in the event that the respective owner/operator makes a pledge or commitment.

With respect to step 20, the digital data device 10 communicates to the server an indication of whether the owner/operator of that device wishes to apply any proceeds of the sale (e.g., other than the credit issued in step 22) to a third-party and, particularly, to a charitable organization. This can be communicated, e.g., by a web page form(s), by special-purpose application or app executing on device 10, or otherwise. Alternatively, or in addition, it can be in response to a query communicated by the server 14 (and, particularly, for example, by the aforementioned e-commerce software executing thereon) to the device 10 in order to elicit its communication of such an indication. The identity of that third party and, particularly, of the charitable organization, can be communicated by the device 10 to the server 14 in connection with any affirmative indication that the owner/operator of the device 10 indeed wishes to apply the proceeds of the sale to such a charity.

With respect to step 28, the server 14 (and, particularly, the aforementioned e-commerce software executing thereon) effects distribution of funds in the amount of the purchase price to bank accounts associated with the third-party charitable organization designated by the seller in step 20. Thus, for example, in some embodiments the entirety of the purchase price (minus the credit C1 and, in some embodiments, also minus the credit C2) is transferred to a bank account to associated with the charity and a tax receipt in that amount is issued to the seller (e.g., by the server 14 in the name of the operator of the digital commerce store). This transfer is typically monetary (e.g., for cash) and, thus, occurs with respect to the bank account associated with the charity and includes issuance of a tax receipt to the seller; though, in other embodiments an in-store credit maybe issued to the charity, instead or in addition. In other embodiments, a fraction of the purchase price funds are transferred to bank accounts associated with creative artists and others behind the digital media object that was the subject of the transaction, again, by way of example. In these and/or other embodiments, a fraction of the funds can additionally be transferred to the operator of the digital commerce store. As above, one or more of the foregoing actions may be deferred until validation in the event that the respective owner/operator makes a pledge or commitment.

Transfer of Ownership to Charity

Alternate embodiments that facilitate such donation operate in the manner shown in FIG. 3 and discussed above, albeit include transferring ownership of (or other rights in) the digital media object from the seller to the charity prior to that object being sold to the buyer. This differs from the embodiment discussed immediately above insofar as, in that prior embodiment, the charity does not take ownership of (or other rights in) the digital media object—but, rather, merely benefits from proceeds of its sale (or other transfer) from the seller to the buyer.

Thus for example, in one such alternate embodiment, upon request of the seller (Owner/Operator 1), e.g., in step 20, the server 14 transfers ownership of (or other rights in) the digital media object being sold from the seller to the charity in step 22, upon issuance of the credit C1 to the owner/operator of device 10. The server 14 can, in connection with that transfer, effect issuance of a tax receipt to the seller, for example, an amount equal to the fair market value and/or average selling price of objects like the digital media object being sold. As above, one or more of the foregoing actions may be deferred until validation in the event that the respective owner/operator makes a pledge or commitment.

In these embodiments, in step 28, the server 14 effects a (i) transfer of ownership of (or other rights in) the digital media object from the charity to the ultimate buyer, here, the owner/operator of device 12, once his/her request has been validated, in exchange for (ii) a transfer of funds in the amount of the purchase price from the buyer to the charity. As above, some of those transferred funds may be distributed to others, for example, some of the funds may be retained by the operator of the digital commerce store and/or may be transferred to bank accounts (or reflected as in-store credit) associated with creative artists and others behind the digital media object that was the subject of the transaction, again, by way of example. Also as above, the transfer of purchase price funds from the buyer may be offset by any credit C2 owed to it the buyer by the digital media store, which offset may be subtracted from the distribution due the charity, the artists (or others), and/or the operator itself. As above, one or more of the foregoing actions may be deferred until validation in the event that the respective owner/operator makes a pledge or commitment.

An advantage of alternate embodiments, e.g., of the type described above, is that they offer the charity the option of selling at higher (or lower) prices—or, put another way, of setting and/or negotiating their own desired selling price with the buyer and not counting on the original seller, i.e., the owner/operator of device 10, to do so. In these and related regards, in some embodiments, the server 14 can forego issuance of a tax receipt to the original seller instep 20 and/or can wait until a final sale and transfer in step 28—issuing, at that time, a tax receipt to the original seller in the amount of the actual sale price.

Encouraging Participation by Buyer

Still other embodiments, operating as discussed above, facilitate donation by (in addition to the mechanisms described above) encouraging participation by the buyer, i.e., the owner/operator of device 12 in the donative transfer. Thus for example in some such embodiments, the buyer can opt to forego offsetting the purchase price by the amount C2, thereby, increasing the amount of the distribution to the charity. In these and related embodiments, the buyer can choose to preferentially purchase digital media objects from (a) sellers who have agreed (e.g., in connection with step 20) to donate their proceeds to charity, or (b) charities. This can be facilitated by the server 14, which can, for example, in step 24, in lists published of digital media objects currently being offered for sale, list, first, those meeting (a) and (b).

### Example

In one exemplary embodiment, a system according to the invention of the type shown in FIG. 3 utilizes digital data devices 10, 12 that are embodied in kiosks disposed for example, at a public (or other) site where a charitable organization is soliciting donations. This may be at, for example, a shopping mall at or around a traditional holiday or other “giving” season. Volunteers for the charity can encourage passersby to donate the proceeds of sales of digital media objects, in lieu of or in addition to donating cash “on the barrelhead.”

To this end, the volunteers can encourage a potential seller (or Owner/Operator 1) to utilize a kiosk-like digital device 10 (or a suitably equipped smart phone, PDA or other mobile computing device) to issue to server 14 a request to sell a digital media object, along with an indication that the owner/operator wishes to apply any proceeds of the sale to that charity. As discussed above in connection with an alternate embodiment, at request of the potential seller, the server 14 can transfer ownership of (or other rights in) the DMO to the charity.

The DMO can be one already stored in space allocated to that owner/operator on that server 14—or it can be a DMO that remains to be uploaded by that owner/operator to that space. In the latter instance, if the DMO is contained on the device 10 (e.g., a smart phone, PDA or other mobile computing device), that device can be operated, e.g., in a manner consistent with that illustrated and described, by way of non-limiting example, in connection with steps 101-108 of aforementioned incorporated-by-reference applications, to upload the DMO to the server 14 and to validate it for sale. On the other hand, if the DMO is contained on some other device owned or controlled by the potential seller (e.g., a device other than device 10 used to issue to server 14 the request to sell the DMO), the potential seller can utilize device 10 to issue to server 14 a request to “automatically” upload the DMO from that other device to that owner/operator's allocated space on the server 14.

Moreover, the volunteers can encourage a potential buyer (or Owner/Operator 2) to utilize a kiosk-like digital device 12 (which may be the same kiosk-like device as digital device 10 discussed above) or a suitably equipped smart phone, PDA or other mobile computing device to issue to server 14 a request to buy the just-offered-for-sale or another digital media object. For example, the request may be in response to a listing published by server 14 of digital media objects from (a) sellers who have agreed to donate their proceeds to the charity, or (b) the charity itself, at a default, agreed-upon or negotiated purchase price. Moreover, the volunteers can encourage the potential buyer to utilize device 12 to transmit to serve 14 an indication that the buyer desires to opt to forego offsetting that purchase price by any credit owed to the buyer, thereby, increasing the amount of the distribution to the charity.

As above, one or more of the actions of these examples may be deferred until validation in the event that the respective owner/operator makes a pledge or commitment.

The system of this example can otherwise operate in accord with that shown in FIG. 3 and discussed above, e.g., vis-à-vis the transfer of monetary funds and/or credits to the charity from the buyer or otherwise.

### CONCLUSION

Described above our systems and methods meeting the objects set forth above. It will be appreciated that the embodiments discussed herein are merely examples of the invention and that other embodiments incorporating changes there to fall within the scope thereof. By way of example, it will be appreciated that systems and methods according to the invention can be used, not only in connection with e-commerce transactions involving digital media objects, but with other e-commerce transactions as well. Moreover, it can be used not only with individual sales of the type shown in FIG. 2 and described above, but also with other events—such as raffles, lotteries, and a variety of other activities by way of e-commerce.

And, by way of further example, the monetary transfers discussed above, e.g., in connection with step 28, can be supplemented and/or replaced by in store credit transfers. Thus, for example, in addition to or in lieu of the funds obtained from the buyer's bank account, the server 14 can, in step 28, distribute in-store credits C2 (owed to the buyer) up to the amount of the purchase price to the seller, the charity, and/or the others discussed above, in lieu of or in addition to monetary funds. Those credits can be distributed as such (i.e., as credits) to each of the recipients and/or they can be distributed in monetary form with such conversion factor as the operator may choose to enforce (e.g., dollar for dollar, $0.95 on the dollar, $0.90 on the dollar, and so forth).

And, by way of still further example, although the digital data devices 10, 12 are typically separate devices owned and/or operated by separate owners/operators, they can in some embodiments be the same device—e.g., a shared public desktop computer or otherwise that is used at different times by such owners/operators.

And, by way of still further example, it will also be appreciated that the mechanisms taught herein can be used with (i) systems in which possession or transfer of a digital media object embodying a particular copy of a creative work can—like the possession or transfer of a physical object (e.g., a book, record album, DVD, etc.) embodying such a particular copy—reflect ownership or transfer thereof, as the case may be, of the digital media object and the particular copy embodied therein, (ii) systems in which ownership or the transfer thereof in a digital media object and/or the particular copy embodied therein or otherwise represented thereby is reflected by a central registry, by links, by pointers or otherwise, as well as with (iii) still other systems now or heretofore known in the art.

In view of the foregoing, what is claimed is:

1. Digital commerce system, comprising
A. a first digital data device,
B. a second digital data device,
C. a server digital data processor that is coupled by a network for least intermittent communications with each of the first and second digital data devices,
D. the server digital data processor being responsive to requests by owners and/or operators (each, hereinafter, respectively an “owner/operator”) of the first and second digital data devices, respectively, for (i) selling or otherwise transferring ownership of or other rights in a digital media object from an owner/operator of the first digital data device to an owner/operator of the second digital data device, and (ii) transferring any of credits and/or monetary funds (collectively, “funds”) from an owner/operator of the second digital data device to a charity designated by the owner/operator of the first digital data device.

2. The digital commerce system of claim 1, wherein the server digital data processor responds to a request by the owner/operator of the first digital data device to transfer ownership of (or other rights in) the digital media object by applying a credit to an account of that owner/operator.

3. The digital commerce system of claim 2, wherein the server digital data processor, in connection with transferring funds (collectively, “funds”) from the owner/operator of the second digital data device to the charity, offsets an amount transferred by a credit owed to that owner/operator.

4. The digital commerce system of claim 3, wherein the server digital data processor, in connection with transferring funds (collectively, “funds”) from the owner/operator of the second digital data device to the charity, is responsive to a request by that owner/operator to forego such offsetting the amount transferred by a credit owed to that owner/operator.

5. The digital commerce system of claim 1, wherein the server digital data processor issues a tax receipt to the owner/operator of the first digital data device.

6. A digital commerce system, comprising
A. a first digital data device,
B. a second digital data device,
C. a server digital data processor that is coupled by a network for least intermittent communications with each of the first and second digital data devices,
D. the server digital data processor being responsive to a request by an owner and/or operator (hereinafter, “owner/operator”) of the first digital data device for transferring ownership of or other rights in a digital media object from an owner/operator of the first digital data device to a designated charity,
E. the server digital data processor being responsive to a request by an owner/operator of the second digital data device by transferring any of credits and/or monetary funds (collectively, “funds”) from that owner/operator to the charity and by transferring ownership of or other rights in the digital media object from the charity to that owner/operator.

7. The digital commerce system of claim 6, wherein the server digital data processor responds to the request by the owner/operator of the first digital data device by applying a credit to an account of that owner/operator.

8. The digital commerce system of claim 6, wherein the server digital data processor responds to the request by the owner/operator of the second digital data device by transferring funds in the amount of a purchase price of the digital media object, offset by a credit owed to that owner/operator.

9. The digital commerce system of claim 6, wherein the server digital data processor normally responds to the request by the owner/operator of the second digital data device by transferring funds in the amount of a purchase price of the digital media object, offset by a credit owed to that owner/operator, but wherein the server is responsive to a request by that owner/operator to forego such offsetting.

10. The digital commerce system of claim 6, wherein the server digital data processor issues a tax receipt to the owner/operator of the first digital data device.

11. A method of digital data commerce, comprising
A. accepting with a server digital data processor a request from a first owner and/or operator (hereinafter, “owner/operator”) via a first digital data device,
B. accepting with a server digital data processor a request from a second owner/operator via a second digital data device,
C. responding, with the server digital data processor, to the requests by owners/operators of the first and second digital data devices, respectively, for (i) selling or otherwise transferring ownership of or other rights in a digital media object from an owner/operator of the first digital data device to an owner/operator of the second digital data device, and (ii) transferring any of credits and/or monetary funds (collectively, “funds”) from an owner/operator of the second digital data device to a charity designated by the owner/operator of the first digital data device.

12. A method of digital commerce, comprising the steps of
A. with a server digital data processor, responding to a request from an owner and/or operator (hereinafter, “owner/operator”) of a first digital data device by transferring ownership of or other rights in a digital media object from that owner/operator to a charity designated thereby,
B. with the server digital data processor, responding to a request from an owner/operator of a second digital data device by transferring any of credits and/or monetary funds (collectively, “funds”) from that owner/operator to the charity and by transferring ownership of or other rights in the digital media object from the charity to that owner/operator.

13. A digital commerce system, comprising
A. one or more digital data devices, at least one of which is embodied in a kiosk,
B. a server digital data processor that is coupled by a network for least intermittent communications with each of the first and second digital data devices,
C. the server digital data processor being responsive to requests by a first and second owners and/or operators (each, hereinafter, respectively an “owner/operator”) of the one or more digital data devices, respectively, for (i) selling or otherwise transferring ownership of or other rights in a digital media object from the first owner/operator, and (ii) transferring any of credits and/or monetary funds (collectively, “funds”) from the second owner/operator to a charity designated by the first owner/operator.

14. The digital commerce system of claim 13, wherein the digital media object is stored on the server digital data processor.

15. The digital commerce system of claim 14, wherein the digital media object is uploaded from the one or more digital data devices to the server digital data processor.

16. The digital commerce system of claim 14, wherein the digital media object is uploaded by the server from a remote digital data device.
